(19) United States
(12) Patent Application Publication
(10) Pub. No.: US 2020/0411965 A1
(43) Pub. Date: Dec. 31, 2020

(54) WIRELESS ACCESS DEVICE

(71) Applicant: AAC Technologies Pte. Ltd., Singapore city (SG)

(72) Inventors: Qingchen Chu, Shenzhen (CN); Hongjun Wang, Shenzhen (CN); Lei Zheng, Shenzhen (CN); Yuehua Yue, Shenzhen (CN)

(21) Appl. No.: 16/993,309

(22) Filed: Aug. 14, 2020

Related U.S. Application Data
(63) Continuation of application No. PCT/CN2019/094085, filed on Jun. 30, 2019.

(51) Int. Cl. H01Q 1/24; H04R 1/02; H01Q 1/02; H01Q 1/42

(52) U.S. Cl. CPC H01Q 1/246; H04R 1/021; H04R 1/028; H01Q 1/42; H01Q 1/02

(57) ABSTRACT

A wireless access device includes a shell, a processing assembly, an antenna assembly, and a deflector. A side plate of the shell is provided with an air inlet hole. A bottom plate of the shell is provided with an air outlet hole. The processing assembly is arranged on the bottom plate and forms a gap with the side plate. The deflector is disposed in the shell and located above the processing assembly. An end surface of an end of the deflector is an inclined surface, and a spacing between the inclined surface and the side plate gradually increases from top to bottom, which can achieve better heat dissipation of the processing assembly through guidance of the deflector to the wind. The wireless access device provided by the present invention also has characteristic of simple structure and convenient production and manufacturing.

### TECHNICAL FIELD

The present invention relates to the technical field of communication devices and, in particular, to a wireless access device.

### BACKGROUND

As the fifth-generation mobile communication technology gradually begins to be commercialized, 5G will bring more and more changes to our lives, especially mobile communication, home intelligence, Internet of Things, and Internet of Vehicles. Consumer Premise Equipment (CPE) is an equipment that can convert mobile communication signals into Wi-Fi signals and then allow users to connect to it, just like that a mobile phone turns on a hot spot. Without doubt, an ability of the mobile phone to have a hot spot cannot be compared with the CPE, a CPE antenna has stronger gain, and when its transmit power is the same as that of the mobile phone, WiFi of the CPE has stronger coverage, so it can support more equipment to access to it, and can have stronger signals than the mobile phone even in various harsh environments, thus application of the CPE is more extensive, and it is favored by people.

However, in the related art, the CPE has a poor heat dissipation effect due to unreasonable structural design, and serious heat generation occurs to the CPE after a period of use.

### SUMMARY

In views of the problem of the poor heat dissipation effect of the CPE due to unreasonable structural design and the serious heat generation occurring to the CPE after a period of use, the present invention provides a wireless access device.

The present invention provides a wireless access device. The wireless access device includes a shell; a processing assembly arranged in the shell and configured to process data; an antenna assembly arranged in the shell and configured to transmit and receiving signals; and a deflector arranged in the shell and located above the processing assembly. The shell includes side plates and a bottom plate, one side plate of the side plates is provided with an air inlet hole, the bottom plate is provided with an air outlet hole, and the processing assembly is vertically arranged on the bottom plate and forms a gap with the one side plate. An end surface of an end of the deflector corresponding to the one side plate is an inclined surface. A spacing formed between the inclined surface and the one side plate increases from top to bottom, in such a manner that external wind flows to the gap under guidance of the inclined surface after entering the shell through the air inlet hole, to achieve heat dissipation of the processing assembly.

As an improvement, the end of the deflector corresponding to the one side plate is provided with a plurality of recesses.

As an improvement, each of two opposite side plates of the side plates of the shell is provided with the air inlet hole.

As an improvement, the wireless access device further includes a fan housing provided at the air inlet hole, and the fan housing is of a horn-shaped structure recessing towards inside of the shell.

As an improvement, the wireless access device further includes a cooling fan located in the shell and disposed on the fan housing.

As an improvement, the processing assembly includes a circuit board and a processor provided on the circuit board, and the antenna assembly includes a 5G antenna, an LTE antenna, and a Wifi antenna that are electrically connected to the circuit board.

As an improvement, the 5G antenna includes a sub-6G antenna and a millimeter wave antenna that are electrically connected to the circuit board.

As an improvement, the shell includes a box and a cover that are detachably connected to each other, and the processing assembly, the antenna assembly and the deflector are provided in the box.

As an improvement, the cover is provided with a snap joint, and the box is provided with a snap groove that matches the snap joint; a decorative strip is provided between the box and the cover and made of an elastic material; and when the snap joint is snapped in the snap groove, the decorative strip is compressed to deform in such a manner that the box and the cover are connected tightly.

As an improvement, a rubber pad is provided at four corners of the bottom plate of the shell.

The present invention, by additionally providing the deflector, provides the end surface of the end of the deflector corresponding to the side plate provided with the air inlet hole as the inclined surface, and makes the spacing between the inclined surface and the side plate provided with the air inlet hole gradually increase from top to bottom, in such a manner that the external wind flows to the gap formed between the deflector and the side plate under guidance of the inclined surface after entering the shell through the air inlet hole, to achieve heat dissipation of the processing assembly. Through guidance to the wind by the deflector, better heat dissipation of the processing assembly can be achieved. The present invention also has advantages of simple structure and convenient production and manufacturing.

### BRIEF DESCRIPTION OF DRAWINGS

FIG. 1 is a perspective diagram of a wireless access device when viewing from one angle.

FIG. 2 is a perspective diagram of a wireless access device when viewing from another angle.

FIG. 3 is a perspective diagram of a wireless access device when one side plate is removed.

FIG. 4 is a perspective exploded schematic diagram of a wireless access device.

FIG. 5 is a perspective exploded schematic diagram of a cover and a decorative strip of a wireless access device.

FIG. 6 is a schematic diagram of a deflector of a wireless access device

### DESCRIPTION OF EMBODIMENTS

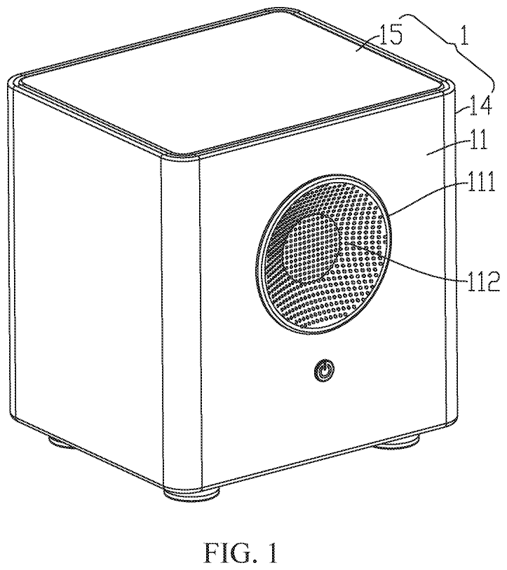

The present invention will be described below in detail with reference to FIG. 1 to FIG. 6.

As shown in FIG. 1, a wireless access device of the present invention includes a shell 1, and the shell 1 includes a box 14 and a cover 15. The box 14 and the cover 15 are detachably connected to each other, which facilitates assembly and disassembly of internal components of the shell 1. In an embodiment, the box 14 is made of plastic by integrally injection molding. The box 14 is of a rectangular structure. The cover 15 is made of plastic by injection molding.

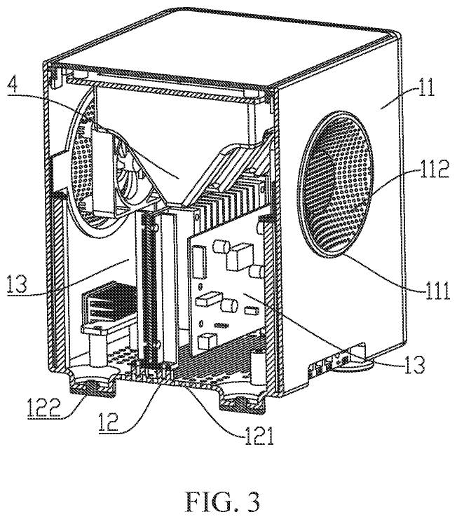

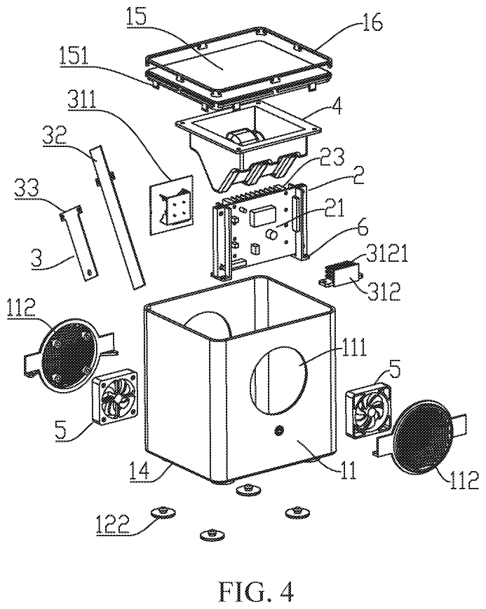

As shown in FIG. 3 and FIG. 4, in an embodiment, the box 14 and the cover 15 are connected by bulking engagement. In an embodiment, the cover 15 is provided with a snap joint 151, and the box 14 is provided with a snap groove that matches the snap joint 151. In another embodiment, a snap groove is provided on the cover 15, and a snap joint that matches the snap groove is provided on the box 14.

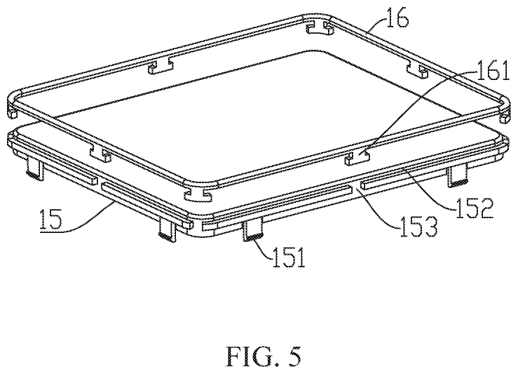

As shown in FIG. 4 and FIG. 5, a decorative strip 16 is further provided between the box 14 and the cover 15, and the decorative strip 16 is made of an elastic material. When the snap joint 151 is snapped in the snap groove, the decorative strip 16 is compressed to deform, in such a manner that the box 14 and the cover 15 are tightly connected. In an embodiment, an upper end of the cover 15 is provided with a mounting slot 152, and the decorative strip 16 is disposed in the mounting slot 152. When the snap joint 151 is snapped in the snap groove, a gap formed between the box 14 and the cover 15 is smaller than a width of the decorative strip 16, in such a manner that the decorative strip 16 is squeezed and compressed to deform, which ensures that there is no gap between the cover 15 and the box 14, thereby avoiding unattractiveness caused by gaps between the assemblies. An upper portion of the decorative strip 16 is of circular arc, and the decorative strip 16 can match colors of the cover 15 and the box 14 to match product appearance colors. The decorative strip 16 is further provided with a hook 161, and the cover 15 is provided with a bayonet 153 matching the hook 161, in such a manner that the decorative strip 16 and the cover 15 are stably connected to each other. In an embodiment, the decorative strip 16 is made of silica gel or rubber.

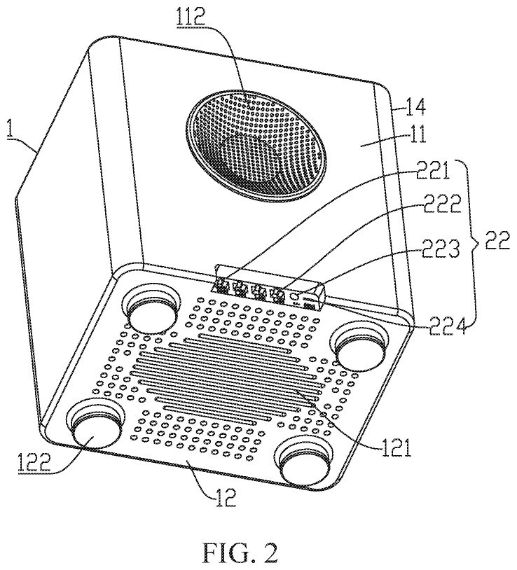

As shown in FIG. 2 to FIG. 4, a processing assembly 2 configured to process data and an antenna assembly 3 configured to transmit and receive signals are arranged in the shell 1. Specifically, both the processing assembly 2 and the antenna assembly 3 are disposed in the box 14. The antenna assembly 3 includes a 5G antenna 31, an LTE antenna 32, and a Wifi antenna 33. The processing assembly 2 includes a circuit board 21 and a processor and a plurality of interfaces 22 provided on the circuit board 21, and the 5G antenna 31, the LTE antenna 32, the Wifi antenna 33, and the plurality of the interfaces 22 are all electrically connected to the circuit board 21.

As shown in FIG. 4, in an embodiment, the processing assembly 2 is fixed to the bottom plate 12 by a fixing bracket 6. The processing assembly 2 is provided with a first heat dissipation fin 23, which can enhance the heat dissipation effect of the processing assembly 2.

As shown in FIG. 2, in an embodiment, the interfaces 22 includes a WAN interface 221, a LAN interface 222, a powers supply interface 3323, and a SIM interface 224. The shell 1 is provided with a plurality of mounting holes corresponding to the WAN interface 221, the LAN interface 222, the power supply interface 3323, and the SIM interface 224, respectively.

As shown in FIG. 4, the 5G antenna 31 includes a sub-6G antenna 311 and a millimeter wave antenna 312, and both the sub-6G antenna 311 and the millimeter wave antenna 312 are electrically connected to the circuit board 21. The millimeter wave antenna 312 is integrated with a wave-controlled active module. The millimeter wave antenna 312 is provided with a second heat dissipation fin 3121, which can enhance the heat dissipation effects of the millimeter wave antenna 312 and the processing assembly 2.

As shown in FIG. 4, a side plate 11 of the shell 1 is provided with an air inlet hole 111, and each of two opposite side plates 11 of the shell 1 is provided with the air inlet hole 111. Through the above configuration, the heat dissipation effect of the equipment becomes better.

As shown in FIG. 1 to FIG. 4, a fan housing 112 is provided at the air inlet hole 111, and the fan housing 112 is of a horn-shaped structure recessing towards inside of the shell 1. Through the above configuration, in one aspect, large particles can be blocked from entering the inside of the shell 1, to ensure normal operating of the equipment, and in another aspect, adopting the concave structure can add more air inlet holes 111 under the same projection area, which can effectively improve the heat dissipation effect of the equipment. In addition, the design of the horn-shaped fan housing 112 makes the wireless access device look like an audio equipment in appearance, so that people's fear of communication radiation can be reduced, and mobile communication-related equipment can be better integrated into living scenes. In an embodiment, the fan housing 112 is a circular stainless-steel mesh structure or a plastic injection hole, or it can be of horn-shaped structures other rectangular shape.

As shown in FIG. 4, the wireless access device further includes a cooling fan 5, and the cooling fan 5 is located in the shell 1 and disposed on the fan housing 112. With the above configuration, an amount of wind entering the shell 1 can be increased, and the heat dissipation effect of the equipment can be enhanced.

As shown in FIG. 2 and FIG. 3, a bottom plate 12 of the shell 1 is provided with an air outlet hole 121, and the processing assembly 2 is vertically arranged at the bottom of the shell 1 and forms a gap 13 with the side plate 11 provided with the air inlet hole 111. The wind entering the shell 1 enter the gap 13 to dissipate heat generated by the processing assembly 2. The air outlet hole 121 can be a strip hole or a circular hole.

As shown in FIG. 3, the wireless access device further includes a deflector 4, and the deflector 4 is disposed in the shell 1 and located above the processing assembly 2. In an embodiment, an upper end of the deflector 4 is fixed on the cover 15. In an embodiment, the deflector 4 is made of plastic by injection molding.

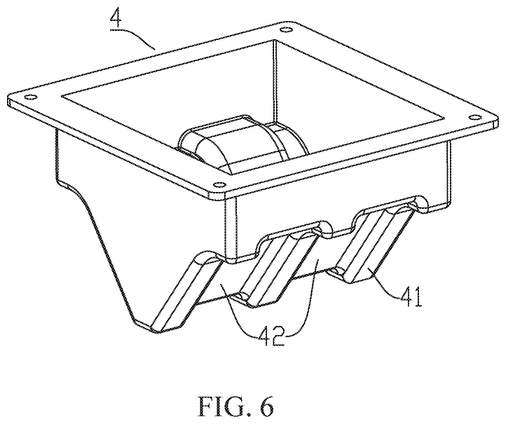

As shown in FIG. 3, FIG. 4 and FIG. 6, an end surface of an end of the deflector 4 corresponding to the side plate 11 provided with the air inlet hole 111 is an inclined surface 41. A spacing between the inclined surface 41 and the side plate 11 provided with the air inlet hole 111 gradually increases from top to bottom, in such a manner that external wind flows to the gap 13 under guidance of the inclined surface 41 after entering the shell 1 through the air inlet hole 111, thereby achieving heat dissipation of the processing assembly 2. By providing the deflector 4 above the processing assembly 2, and the end surface of the end of the deflector 4 corresponding to the side plate 11 provided with the air inlet hole 111 being the inclined surface 41, and the spacing between the inclined surface 41 and the side plate 11 provided with the air inlet hole 111 gradually increasing from top to bottom, the external wind can flow to the gap 13 under the guidance of the inclined surface 41 after entering the shell 1 through the air inlet hole 111, in order to achieve the heat dissipation of the processing assembly 2 and good heat dissipation effect.

As shown in FIG. 6, the end of the deflector 4 corresponding to the side plate 11 provided with the air inlet hole 111 is provided with a plurality of recesses 42. With the above configuration, after the external wind enters the shell 1, it first converges in the recess 42 and then concentrates to flow downwards to the gap 13, which can prevent the wind from disturbing the flow in the shell 1 and improve the heat dissipation effect.

As shown in FIG. 2 to FIG. 4, rubber pads 122 are respectively provided at corners of the bottom of the bottom plate 12 of the shell 1. With the above configuration, in one aspect, damage to the bottom plate 12 can be avoided due to a slide-proof, anti-friction, and cushioning effects of the rubber pad; in another aspect, a distance between the bottom plate 12 and a surface on which the wireless access device is placed when in use can be increased, which facilitates the heat dissipation of the air outlet hole 121 arranged on the bottom plate 12. In an embodiment, protrusions protruding outwards are provided at corners of the bottom of the bottom plate 12, the protrusion is provided with a mounting hole, and an upper end of the rubber pad 122 is snapped in the mounting hole.

The wireless access device further includes a power supply source configured to supply power to the processing assembly 2 and the antenna assembly 3. The shell 1 is further provided with a switch configured to control conduction or cutting-off of the power supply source (referring to FIG. 1).

It should be noted that, the above are merely embodiments of the present invention, those skilled in the art can make improvements without departing from the inventive concept of the present invention, however, these improvements shall fall into the protection scope of the present invention.

What is claimed is:

1. A wireless access device, comprising:
a shell,
a processing assembly arranged in the shell and configured to process data;
an antenna assembly arranged in the shell and configured to transmit and receive signals; and
a deflector arranged in the shell and located above the processing assembly,
wherein the shell comprises side plates and a bottom plate, one side plate of the side plates is provided with an air inlet hole, the bottom plate is provided with an air outlet hole, and the processing assembly is vertically arranged on the bottom plate and forms a gap with the one side plate;
an end surface of an end of the deflector corresponding to the one side plate is an inclined surface; and
a spacing formed between the inclined surface and the one side plate increases from top to bottom, in such a manner that external wind flows to the gap under guidance of the inclined surface after entering the shell through the air inlet hole, to achieve heat dissipation of the processing assembly.

2. The wireless access device as described in claim 1, wherein the end of the deflector corresponding to the one side plate is provided with a plurality of recesses.

3. The wireless access device as described in claim 1, wherein each of two opposite side plates of the side plates of the shell is provided with the air inlet hole.

4. The wireless access device as described in claim 2, wherein each of two opposite side plates of the side plates of the shell is provided with the air inlet hole.

5. The wireless access device as described in claim 1, further comprising:
a fan housing provided at the air inlet hole, the fan housing being of a horn-shaped structure recessing towards inside of the shell.

6. The wireless access device as described in claim 5, further comprising:
a cooling fan located in the shell and disposed on the fan housing.

7. The wireless access device as described in claim 1, wherein the processing assembly comprises a circuit board and a processor provided on the circuit board, and the antenna assembly comprises a 5G antenna, an LTE antenna, and a Wifi antenna that are electrically connected to the circuit board.

8. The wireless access device as described in claim 7, wherein the 5G antenna comprises a sub-6G antenna and a millimeter wave antenna that are electrically connected to the circuit board.

9. The wireless access device as described in claim 1, wherein the shell comprises a box and a cover that are detachably connected to each other, and the processing assembly, the antenna assembly and the deflector are provided in the box.

10. The wireless access device as described in claim 9, wherein the cover is provided with a snap joint, and the box is provided with a snap groove that matches the snap joint; a decorative strip is provided between the box and the cover and made of an elastic material; and when the snap joint is snapped in the snap groove, the decorative strip is compressed to deform in such a manner that the box and the cover are connected tightly.

11. The wireless access device as described in claim 1, wherein a rubber pad is provided at four corners of the bottom plate of the shell.
